(19) United States
(12) Patent Application Publication
(10) Pub. No.: US 2004/0169889 A1
(43) Pub. Date: Sep. 2, 2004

(54) Image processing apparatus and controller apparatus using thereof

(75) Inventor: Takayuki Sawada, Numazu-shi (JP)

Correspondence Address: FOLEY AND LARDNER, SUITE 500, 3000 K STREET NW, WASHINGTON, DC, 20007, US

(73) Assignee: Toshiba Tec Kabushiki Kaisha

(21) Appl. No.: 10/373,790

(22) Filed: Feb. 27, 2003

(51) Int. Cl. H04N 1/60

(52) U.S. Cl. 358/2.1; 358/518; 358/523; 358/520; 358/3.24

(57) ABSTRACT

This invention provides an image processing apparatus comprising a color distribution analyzing portion for analyzing color distribution of an inputted color image, an image content judgment portion for judging the content of a color image based on the analyzed color distribution, a color conversion parameter determining portion for determining a color conversion parameter based on the judged image content, and a color conversion portion which executes color conversion upon a color image based on this color conversion parameter.

### BACKGROUND OF THE INVENTION

Conventionally, color management of an image processing apparatus such as multi-function printer (MFP) and an ordinary printer has a basic structure of absorbing differences in color characteristics among apparatuses, and when an apparatus configuration for image processing is determined, its color reproduction characteristics is automatically determined. Although the color MFP has a function of adjusting color tone through a control panel, a feature that the color reproduction characteristics is automatically determined is substantially not different because color condition after the adjustment is fixed. This kind of technique has been disclosed in Jpn. Pat. Appln. KOKAI Publication No. 11-55541, which proposes an image processing apparatus executing color correction processing on which the content of image data is not reflected.

On the other hand, color management field demands image output with preferable color reproduction to a producer and an observer. The preferable color reproduction has some policies (color reproduction target) including color reproduction faithful to an original, color reproduction which is not faithful but beautiful and comfortable, color reproduction following preliminarily determined colors, and an optimum policy differs depending on the content of an image and an image object. For example, generally, color reproduction comfortable to the eyes is demanded for such image objects as human skin, natural scene components (sky, tree's green and the like), fresh foods (red meal) and the like, and there is a need that the color of a logo mark is demanded to be expressed in corporate color.

However, the above-mentioned conventional apparatus has such a problem that it is incapable of reproducing optimum colors for the content of image and its image object because it does not take the content indicated by the image data into account, and a color reproduction parameter is fixed.

### BRIEF SUMMARY OF THE INVENTION

An object of the present invention is to provide an image processing apparatus which judges the content of an image indicated by an image data to be processed and executes color correction processing according to optimum color correction parameter suitable for the content of an image and a controller apparatus using the same.

To achieve the above-described object, the present invention provides an image processing apparatus comprising: a color distribution analyzing portion for analyzing a color distribution of an inputted color image; an image content judgment portion for judging the content of the inputted color image based on the color distribution analyzed by the color distribution analyzing portion; a color conversion parameter determining portion for determining the color conversion parameter based on the image content judged by the image content judgment portion; and a color conversion portion for applying color conversion to the inputted color image based on the color conversion parameter determined by the color conversion parameter determining portion.

The image processing apparatus of the present invention does not apply uniform color correction to image data but judges the content of the image indicated by the image data, for example, human figure, natural scenery image, graphic or the like, and then carries out image correction using correction parameter appropriate to this. For example, in the case of human figure, its color correction is carried out based on a color correction parameter prepared preliminarily to achieve optimum color expression for human skin. The same applies to the natural scenery in which green is to be stressed or a graphic in which fresh colors without muddiness are required. Consequently, the present invention provides an image processing apparatus capable of executing color conversion to express colors most faithfully which the image data intends to express.

### BRIEF DESCRIPTION OF THE SEVERAL VIEWS OF THE DRAWING

FIG. 1 is a block diagram of an image processing apparatus which executes a first adaptive color conversion of the present invention;

FIG. 2 is a block diagram of an image processing apparatus which executes a second adaptive color conversion of the present invention;

FIG. 3 is a block diagram of an image processing apparatus which executes a third adaptive color conversion of the present invention;

FIG. 4 is a flow chart showing switching of color conversion parameter based on spatial features;

FIG. 5 is a schematic diagram of a multi-dimension color conversion table for explaining a first generation method of a color adjustment reflecting color conversion table;

FIG. 6 is a schematic diagram of a multi-dimension color conversion table for explaining a second generation method of a color adjustment reflecting color conversion table;

FIG. 7 is a schematic diagram of a multi-dimension color conversion table for explaining a third generation method of a color adjustment reflecting color conversion table;

FIG. 8 is a block diagram of a scanner controller to which the present invention is applied; and

FIG. 9 is a block diagram of a printer controller to which the present invention is applied.

### DETAILED DESCRIPTION OF THE INVENTION

Hereinafter, the image processing apparatus of the present invention and the controller apparatus using the same will be described referring to the accompanying drawings.

<First Image Processing Apparatus>

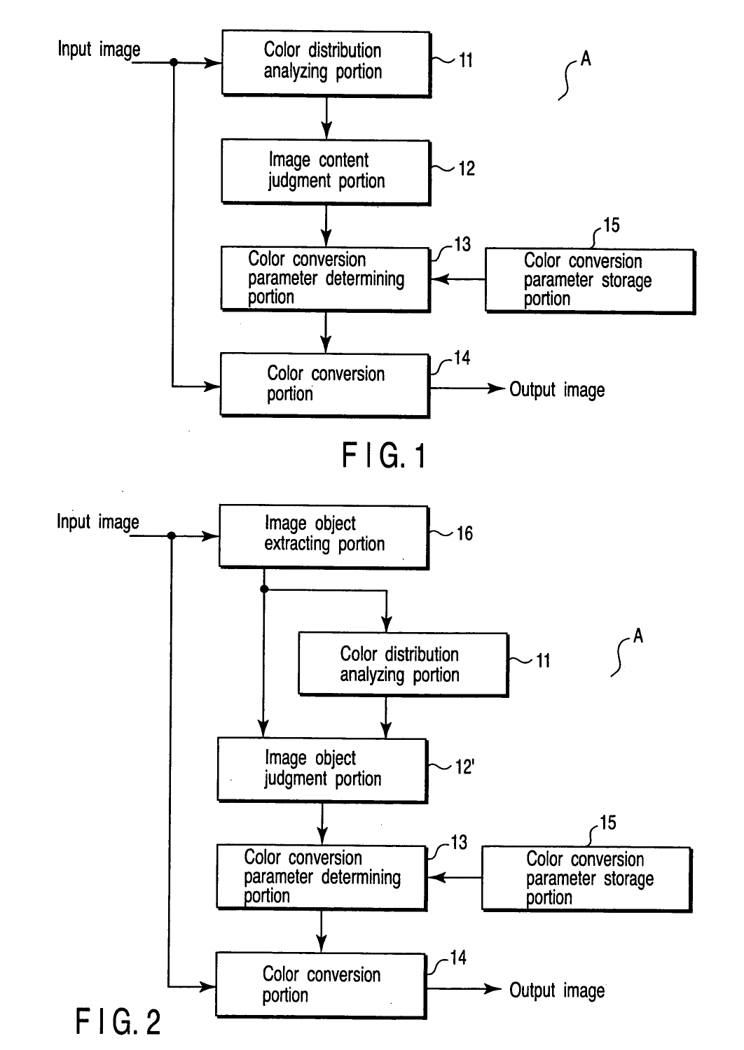

A first image processing apparatus determines the content of an image data and converts colors with optimum color conversion parameters to carry out a color correction corresponding thereto. FIG. 1 is a block diagram of the image processing apparatus which executes a first adaptive color conversion according to the present invention.

The first image processing apparatus A according to the present invention comprises a color distribution analyzing portion 11 which is supplied with an input image, an image content judgment portion 12 which is supplied with this output and a color conversion parameter determining portion 13 which is supplied with a signal indicating the judged image content. Further, it further comprises a color conversion parameter memory portion 15 which is supplied with color conversion parameter recorded preliminarily in the color conversion parameter determining portion 13 and a color conversion portion 14 which is supplied with the determined color conversion parameter so as to converts colors of the input image.

Hereinafter, an operation of the first image processing apparatus will be described.

First, the input image is inputted to the color distribution analyzing portion 11. The color distribution analyzing portion 11 generates a histogram of a pixel value expressed with multi-dimensional coordinates like (R, G, G), (L*, a*, b*), (X, Y, Z). Because the color coordinates are expressed with three-dimensional coordinates in many cases as described above, the histogram of the pixel value is expressed with three-dimensional histogram. If the color space of the input image is expressed with XYZ color space, it is permissible to generate and use a two-dimensional histogram of xy chromaticity coordinates defined by x=X/(X+Y+Z), y=Y/(X+Y+Z). The generated pixel value histogram is inputted to the image content judgment portion 12.

The image content judgment portion 12 judges the content of the input image based on the features of distribution of the pixel value histogram. As an example of judgment on the content of an image, if a pixel belonging to the skin color appears frequently, the image is judged to be a human image (portrait). If colors belonging to memory color like blue and green appear frequently and the distribution of blue or green has a larger spreading than a predetermined level, that image is judged to be a natural scenery image. If there is a lump of color distribution and that lump has a smaller spreading than a predetermined level, that image is judged to be graphic. The image is judged according to such a judgment standard. A judgment result of the image content is inputted to the color conversion parameter determining portion 13.

The color conversion parameter determining portion 13 selects a color conversion parameter related to the image content preliminarily from multiple color conversion parameters stored in the color conversion parameter memory portion 15 and supplies its result to the color conversion portion 14. The color conversion parameter storage portion 15 is a storage portion which stores multiple color conversion parameters as described above.

An input image inputted to the image processing apparatus A according to the present invention is inputted to the color distribution analyzing portion 11 and at the same time, the color conversion portion 14. The color conversion portion 14 is a block which executes map conversion of the input image to other color spaces. Depending on an application of the image processing apparatus, mapping between the same color spaces is sometimes carried out (L* a* b* to L* a* b*, for example). The color conversion portion 14 converts colors of the input image using the color conversion parameters supplied from the color conversion parameter determining portion 13 so as to output the resulting image.

As described in detail above, the image processing apparatus of the present invention does not execute automatic color correction fixedly to the input image unlike a conventional apparatus, but determines the content of the input image and if a human image is provided, carries out an optimum color correction corresponding to the content of the image so as to express the color of skin optimally. Consequently, this image processing apparatus achieves color expression by accurate color conversion.

<Second Image Processing Apparatus>

A second image processing apparatus extracts an image object such as figure, from image data and executes the color conversion of the above-described first image processing apparatus upon this extracted image object. FIG. 2 is a block diagram of the image processing apparatus which executes a second adaptive color conversion according to the present invention.

Referring to FIG. 2, the second image processing apparatus A according to the present invention comprises an image object extracting portion 16, a color distribution analyzing portion 11 which is supplied with an image of an extracted image object, an image object judgment portion 12′ which is supplied with this output and an image of the image object and a color conversion parameter determining portion 13 which is supplied with a signal indicating the content of a judged image. It further comprises a color conversion parameter storage portion 15 which is supplied with a color conversion parameter stored preliminarily in the color conversion parameter determining portion 13 and a color conversion portion 14 which is supplied with the determined color conversion parameter so as to execute the color conversion upon the input image.

Hereinafter, an operation of the second image processing apparatus will be described. First, the input image is inputted to the image object extracting portion 16. Depending on color distribution of a pixel constituting an image and spatial features of the image, the image object extracting portion 16 divides the input image to a main image object and other portion (hereinafter referred to as background), supplies each pixel with attribute information indicating which it is an image object or background and then supplies that the attribute information to the color distribution analyzing portion 11 and the image object judgment portion 12′.

With respect to the image data with attribute information supplied from the image object extracting portion 16, the color distribution analyzing portion 11 generates a histogram of the pixel value of each image object. Because the pixel value is expressed on three-dimensional coordinates in many cases like (R, G, B), (L*, a*, b*), (X, Y, Z), the histogram of the pixel value is expressed with a three-dimensional histogram. If the color space of the input image is expressed with XYZ color space, it is permissible to generate and use a two-dimensional histogram of xy chromaticity coordinates defined by x=X/(X+Y+Z), y=Y/(X+Y+Z). The generated pixel value histogram is inputted to the image object judgment portion 12′.

The image object judgment portion 12′ judges the content of the input image based on the features of distribution of the pixel value histogram. As an example of judgment on the content of an image, if a pixel belonging to the skin appears frequently, the image is judged to be a human image. If colors belonging to memory color like blue and green appear frequently and the distribution of blue or green has a larger spreading than a predetermined level, that image is judged to be a component of natural scenery image, such as sky and lawn. If there is a lump of color distribution and that lump has a smaller spreading than a predetermined level, that image is judged to be a graphic object. The image is judged according to such a judgment standard. The image object judgment portion 12′ replaces the attribute information which only distinguishes the image object with attribute information indicating a judgment result of the image object and supplies the result to the color conversion parameter determining portion 13.

The color conversion parameter determining portion 13 selects a color conversion parameter related to the image object preliminarily of each pixel from multiple color conversion parameters stored in the color conversion parameter storage portion 15 and supplies it to the color conversion portion 14 synchronously with color conversion of the input image. The color conversion parameter storage portion 15 is a storage portion which stores multiple color conversion parameters as described above.

The input image inputted to this image processing apparatus is inputted not only to the image object extracting portion 16 but also to the color conversion portion 14. The color conversion portion 14 is a block which executes map conversion of the input image to other color spaces. Depending on an application of the image processing apparatus, mapping between the same color spaces is sometimes carried out (from L* a* b* to L* a* b*, for example). The color conversion portion 14 converts colors of the input image using the color conversion parameters supplied from the color conversion parameter determining portion 13 and outputs an image which is a color conversion result.

As described in detail above, the second image processing apparatus can extract an image object which exists in a page of an image and necessitates a special adjustment, judge the content of the image object and apply a color conversion parameter suitable for the content of each image object. Consequently, an appropriate color reproduction is enabled for all image regions.

<Third Image Processing Apparatus>

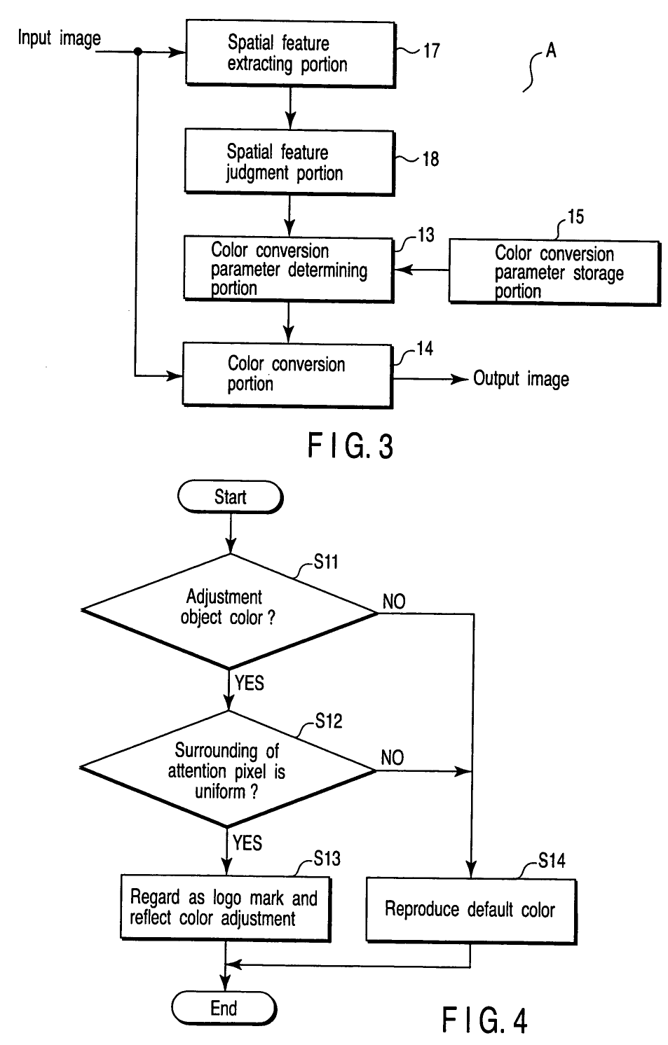

A third image processing apparatus detects, for example, an artificial region such as logo mark, namely, local spatial features from the image data and executes an optimum color conversion thereon. The local spatial features mentioned here may include a case of a uniform color region with a specific color, a case of color region by regular gradation, a case of artificial color region having a regularity like rainbow color and the like. FIG. 3 is a block diagram of an image processing apparatus which executes the third adaptive color conversion according to the present invention.

As shown in FIG. 3, the third image processing apparatus A comprises a spatial feature extracting portion 17, a spatial feature judgment portion 18, a color conversion parameter determining portion 13, a color conversion parameter storage portion 15 and a color conversion portion 14.

Hereinafter, an operation of the third image processing apparatus will be described. First, the input image is inputted to the spatial feature extracting portion 17. The spatial feature extracting portion 17 evaluates correlation of the input image of each pixel with surrounding neighboring pixels and calculates a local spatial feature amount. The calculated spatial feature amount is supplied to the spatial feature judgment portion 18.

The spatial feature judgment portion 18 discriminates whether or not an attention pixel is such a graphic object as logo mark based on the pixel value of the attention pixel and a local spatial feature amount in the neighborhood of the attention pixel, adds discrimination result (attribute information) to each pixel of the input image and supplies it to the color conversion parameter determining portion 13. FIG. 4 shows an example of the discrimination flow chart. The example shown in FIG. 4 indicates a processing for reproducing a predetermined adjusted color for a logo mark.

According to the flow chart of FIG. 4, whether or not the attention pixel is a similar color to the log mark, in other words, whether or not it is an adjustment object color is determined according to its pixel value (S11). Unless it is the adjustment object color, it is determined that that pixel is a not logo mark and a color conversion parameter which is a default in color conversion on subsequent step is employed (S14).

On the other hand, in the case of the adjustment object color, whether or not the surrounding of the attention pixel is uniform is determined according to the spatial feature amount (S12). If the surrounding of the attention pixel is uniform, it is determined that it is a logo mark (S13). Then, the color conversion parameter adjusted for the logo mark in the color conversion on subsequent step is applied.

The color conversion parameter determining portion 13 selects a color conversion parameter related to the image object preliminarily of each pixel from multiple color conversion parameters stored in the color conversion parameter storage portion 15 and supplies it to the color conversion portion 14 synchronously with color conversion of the input image. The color conversion parameter storage portion 15 is a storage portion which stores multiple color conversion parameters as described above.

The input image inputted to this image processing apparatus is inputted to not only the spatial feature extracting portion 17 but also the color conversion portion 14. The color conversion portion 14 is a block which executes map conversion of the input image to other color spaces. Depending on an application of the image processing apparatus, mapping is sometimes carried out between the same color spaces (from L* a* b* to L* a* b*, for example). The color conversion portion 14 converts colors of the input image using a color conversion parameter supplied from the color conversion parameter determining portion 13 and outputs the resulting image.

As described above, the third image processing apparatus according to the present invention recognizes the logo mark and the like as local spatial features and detects it, and then converts colors using an optimum color conversion parameter, so that corporate logo mark or the like whose color is not expected to be changed can be reproduced faithfully.

Next, a production method of the color conversion table for use in the image processing apparatus according to the present invention will be described.

<First Generation Method of the Color Conversion Table According to the Present Invention>

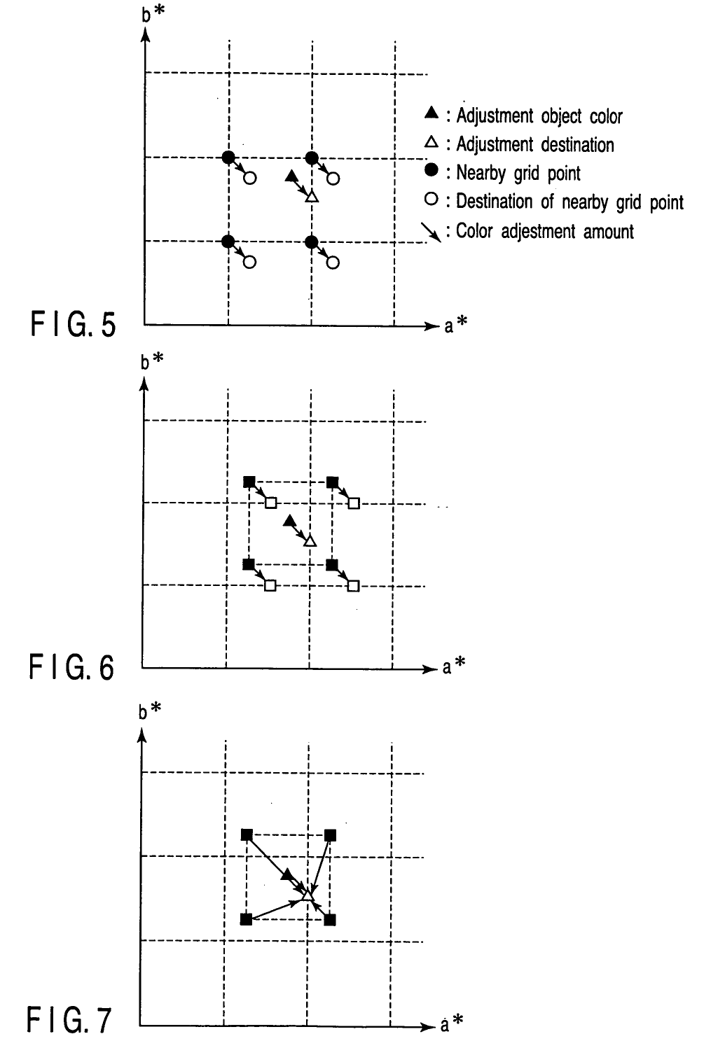

According to the generation method of a first color conversion table, multiple nearby entries are provided around an adjustment object color in the color conversion table, which is a default, and they are moved in the same amount as the adjustment object color so as to produce a color conversion table. FIG. 5 is a schematic diagram of a multi-dimensional color conversion table for explaining a first generation method of the color adjustment reflecting color conversion table.

A first method for producing a color conversion table (=color adjustment reflecting color conversion table) in which a specific image object color undergoes color adjustment will be described in detail. In a schematic diagram of the multi-dimensional color conversion table of FIG. 5, a two-dimensional table in which with the table address color space set to L* a* b*, the L* axis is omitted for simplification of the representation, is shown. Where, it is assumed that the adjustment object color is ▴, an intersection of dotted lines is a color conversion table grid point and ● are nearby grid points which are multiple entries, surrounding an adjustment object color. If an adjustment destination of the adjustment object color is assumed to be Δ, the adjustment amount is expressed as a vector amount directing from ▴ to Δ. This vector amount will be called color adjustment vector.

According to the present invention, as the first production method of the color adjustment reflecting color conversion table, multiple nearby grid points ● are moved by the same amount as the color adjustment vector and a color conversion result is calculated about a point ∘ after moving using the default color conversion table so as to adopt this as a memory value of a corresponding grid point. This conversion table is produced by, for example, the color conversion parameter determining portion 13 shown in FIGS. 1 to 3. A difference of the color adjustment reflecting color conversion table of the first production method from the default color conversion table is just a memory value of the nearby grid point ● and the memory values of the other grid points are equal to default. Thus, when the color adjustment reflecting color conversion table is actually mounted, an entire table does not have to be produced, but it is satisfactory if only the memory value of the nearby grid point ● is maintained.

As described above, according to the first generation method of the color conversion table of the present invention, a color conversion table for use in color conversion processing can be generated from the default color conversion table through a very simple processing.

<Second Generation Method of the Color Conversion Table According to the Present Invention>

According to the generation method of the second color conversion table, multiple nearby entries are provided around an adjustment object color in the color conversion table, which is a default, such that those nearby entries are located at an equal distance from the adjustment object color, and they are moved in the same amount as the adjustment object color so as to produce a color conversion table. FIG. 6 is a schematic diagram of a multi-dimensional color conversion table for explaining a second generation method of the color adjustment reflecting color conversion table.

The second production method of the color adjustment reflecting color conversion table will be described. FIG. 6 shows a schematic diagram of the multi-dimensional color conversion table. The meaning of each numeral is the same as FIG. 5. The production of this conversion table is carried out by, for example, the color conversion parameter determining portion 13 shown in FIGS. 1 to 3. According to the second production method, instead of the grid point ● of the first production method, reference points ▪ are newly provided at a coordinate position located at an equal distance from an adjustment object color ▴ such that those points surround ▴ as multiple-entry reference points for color conversion. As for how to obtain the memory value of a color conversion result of the new reference point ▪, first the new reference point ▪ is moved by an equal amount to the color adjustment vector like the grid point ● according to the first method. Next, a color conversion result is calculated using the default color conversion table for a point □ after the moving so as to regard that point as a memory value of the new reference point ▪. A difference of the color adjustment reflecting color conversion table according to the second production method from the default color conversion table is only a memory value of the new reference point and the memory values of all the grid points are equal to default. Therefore, when loading the color adjustment reflecting color conversion table, it is not necessary to produce an entire table, and it is sufficient if only the memory value of the new reference point ▪ is held.

Because according to the second color adjustment reflecting color conversion table, the nearby entries are provided at an equal distance form an adjustment object color, a color conversion table having no deflection can be generated using the default color conversion table through a very simple processing.

<Third Generation Method of Color Conversion Table According to the Present Invention>

According to a third color conversion table generation method, multiple nearby entries are provided around an adjustment object color in a default color conversion table and these entries are made equal to values after conversion of the adjustment object color so as to produce a color conversion table. FIG. 7 is a schematic diagram of the multi-dimensional color conversion table for explaining the third generation method of the color adjustment reflecting color conversion table.

The third production method of the color adjustment reflecting color conversion table will be described. FIG. 7 shows a schematic diagram of the multi-dimensional color conversion table. The meaning of each symbol is the same as FIG. 5. Production of this conversion table is carried out by, for example, the color conversion parameter determining portion 13 shown in FIGS. 1 to 3. In the third production method, its method to obtain the memory value of the color conversion result of the new reference point ▪ is different from the second production method. That is, all the new reference points ▪, which are multiple entries, are moved to an adjustment destination Δ of the adjustment object color. A color conversion result is obtained through calculation by using the default color conversion table for a point □ after the moving and this value is regarded as the memory value of a corresponding reference point ▪. Therefore, it comes that four memory values ▪ in FIG. 7 are equal. A difference of the color adjustment reflecting color conversion table according to the third production method from the default color conversion table is only the memory value of the new reference point ▪ and the memory values of all the all the grid points are equal to the default. Therefore, when loading the color adjustment reflecting color conversion table, it is not necessary to produce an entire table but it is sufficient if only the memory value of the new reference point ▪ is held.

According to the third color adjustment reflecting color conversion table production method, by setting the destinations of all the nearby entries to a value after conversion of the adjustment object color, the color conversion table can be generated easily by using the default color conversion table. Particularly, color conversion optimum for color correction of logo mark and the like is enabled.

<Application of Color Conversion Table>

Next, an application example of the color adjustment reflecting color conversion table will be described. The color adjustment reflecting color conversion table is applied to a scene, image object and other objects (hereinafter referred to as object) necessitating color reproduction different from default color reproduction in the first to third image processing apparatuses. That is, a typical color of the color adjustment object is handled as an adjustment object color ▴. It is considered that the color of a color adjustment object in the input image (image before color conversion) is distributed with a spreading to some extent. Thus, the color adjustment reflecting color conversion table is applied to nearby colors of the adjustment object color ▴.

Particularly, the logo mark, which should be reproduced with uniform colors, may sometimes have distributions in color spreading when it turns to an scanner input image. In such a case, the color adjustment reflecting color conversion table of the third production method is employed. Consequently, all the color conversion results of colors constituting that logo mark become equal to color conversion results of adjustment destination colors Δ, so that those colors are reproduced with uniform colors.

Next, as a system adopting the image processing apparatus according to the present invention, configuration examples of the scanner controller and printer controller will be described below.

<Scanner Controller>

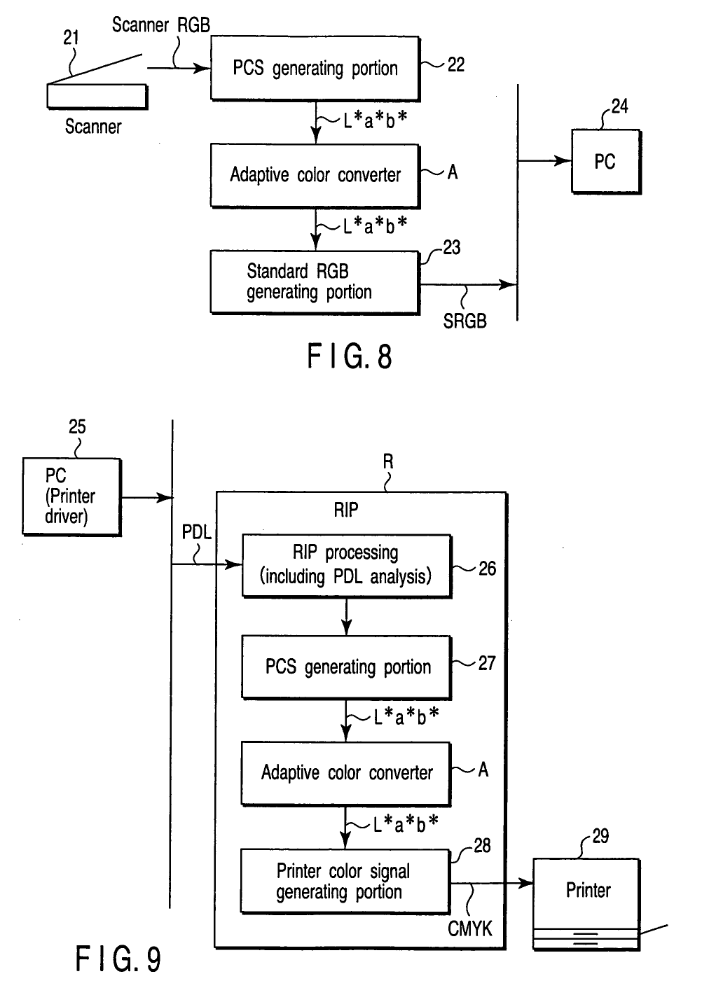

The scanner controller which uses the image processing apparatus performing the adaptive color conversion according to the present invention as an adaptive color converter will be described below. FIG. 8 is a block diagram of the scanner controller employing the present invention.

Referring to FIG. 8, the scanner controller of the present invention comprises a scanner portion 21, a PCS generating portion 22 which receives scanner RGB from this, an adaptive color converter A according to the present invention and a standard RGB generating portion 23.

The scanner RGB fetched from the scanner portion 21 into system is converted from the scanner RGB signal to standard color space signal (PCS: profile connection space, more specifically, L* a* b*) by the PCS generating portion 22 referring to the scanner profile. Image data expressed in this standard color space is inputted to the adaptive color converter A according to the present invention. As described in detail in FIG. 1, FIG. 2 and FIG. 3, the adaptive color converting portion A extracts a color adjustment object, switches the color conversion parameter for each pixel based on its result to perform color conversion and then outputs a result. The adaptive color conversion of this case is map conversion within the PCS. An output signal from the image processing apparatus is converted to standard RGB signals such as sRGB and outputted through the scanner controller.

<Printer Controller>

Next, the printer controller which uses the image processing apparatus performing the adaptive color conversion according to the present invention as an adaptive color converter will be described below. FIG. 9 is a block diagram of the printer controller adopting the present invention.

This printer controller R comprises, as shown in FIG. 9, an RIP processing portion 26 which is supplied with a PDL signal from an outside PC 25, a PCS generating portion 27 which receives its output, an image processing unit A which receives standard color space signals L* a* b* which are outputs thereof and a printer color signal generating portion 28 which receives standard color space signals L* a* b* which are outputs thereof.

A PDL type image outputted from a printer driver on a client PC 25 is supplied to the printer controller R and developed as a raster image by the RIP portion 26. Further, if a printer CMYK signal is outputted by color management function within the RIP portion 26, the PCS generating portion 27 converts this data to standard color space (PCS: profile connection space) using a printer color profile. Image data expressed in this standard color space is inputted to the adaptive color converter of the present invention. As described in detail in FIG. 1, FIG. 2 and FIG. 3, the adaptive color converter A extracts a color adjustment object, switches the color conversion parameter for each pixel based on its result so as to perform the color conversion, and then supplies an output thereof to the printer color signal generating portion 28. Further, the printer color signal generating portion 28 converts from the standard color signal (L* a* b*, for example) to a printer CMYK signal and outputs its result.

Because the above-described operation and effect are obtained with respect to an image fetched in from a scanner by applying the image processing apparatus, which is the adaptive color converter A according to the present invention, as the printer controller R shown in FIG. 9, human figures, natural scenery image, logo mark and the like can be expressed with appropriate colors which those images intend.

As described above, the image processing apparatus according to the present invention executes appropriate color conversion corresponding to the content expressed by the image object instead of the uniform color conversion which the conventional apparatus executes. Consequently, optimum color expression considering the nature of human figures, scenery, logo mark or the like is achieved. Additionally, the color conversion parameter for use for this purpose can be generated through an easy operation.

What is claimed is:

1. An image processing apparatus comprising:
A color distribution analyzing portion for analyzing a color distribution of an inputted color image;
an image content judgment portion for judging the content of the inputted color image based on the color distribution analyzed by the color distribution analyzing portion;
a color conversion parameter determining portion for determining the color conversion parameter based on the image content judged by the image content judgment portion; and
a color conversion portion for executing color conversion upon the inputted color image based on the color conversion parameter determined by the color conversion parameter determining portion.

2. An image processing apparatus according to claim 1, wherein the image content judgment portion judges the content of the inputted color image to be at least one of human figure, natural scenery image and graphic.

3. An image processing apparatus comprising:
an image object extracting portion for extracting an image in a predetermined image object region from an inputted color image;
a color distribution analyzing portion for analyzing color distribution of the image in the image object region extracted by the image object extracting portion;
an image content judgment portion for judging the content of the image in the image object region based on the color distribution analyzed by the color distribution analyzing portion;
a color conversion parameter determining portion for determining a color conversion parameter based on the image content judged by the image content judgment portion; and
a color conversion portion for executing color conversion upon the image in the image object region based on the color conversion parameter determined by the color conversion parameter determining portion.

4. An image processing apparatus according to claim 3, wherein the image content judgment portion judges the content of an image in the image object region to be at least one of human figure, natural scenery image and graphic.

5. An image processing apparatus comprising:
a spatial feature extracting portion for extracting local spatial features from an entire range of an inputted color image;
a spatial feature judgment portion for judging the spatial features extracted by the spatial feature extracting portion;
a color conversion parameter determining portion for determining a color conversion parameter based on a judgment result of the spatial feature judgment portion; and
a color conversion portion for executing color conversion upon the inputted color image based on the color conversion parameter determined by the color conversion parameter determining portion.

6. An image processing apparatus according to claim 5, wherein the spatial feature judgment portion judges that a specific region of the inputted color image is a logo mark based on spatial features extracted by the spatial feature extracting portion.

7. An image processing apparatus comprising:
a specific color conversion table generating portion in which while a specific color of an inputted color image undergoes color conversion using a specific color conversion table, when the color conversion is executed upon a color image other than the specific color using a default color conversion table, the specific color conversion table is generated by changing values of nearby entries surrounding the color coordinate of the specific color in the default color conversion table; and
a color conversion portion which when at least part of the inputted color image is the specific color, the inputted color image undergoes color conversion based on the specific color conversion table generated by the specific color conversion table generating portion.

8. An image processing apparatus according to claim 7, wherein in the specific color conversion table generated by the specific color conversion table generating portion, the nearby entries are supplied with an equal moving amount to the moving amount of the specific color.

9. An image processing apparatus according to claim 7, wherein in the specific color conversion table generated by the specific color conversion table generating portion, the nearby entries are converted to the same color information as color information after the conversion of the specific color.

10. An image processing apparatus comprising:
a specific color conversion table generating portion in which while a specific color of an inputted color image undergoes color conversion using a specific color conversion table, when the color conversion is executed upon a color image other than the specific color using a default color conversion table, the specific color conversion table is generated by providing multiple nearby entries at equal positions from the color coordinate of the specific color and then changing values of the entries in the default color conversion table; and
a color conversion portion which when at least part of the inputted color image is the specific color, the inputted color image undergoes color conversion based on the specific color conversion table generated by the specific color conversion table generating portion.

11. An image processing apparatus according to claim 10, wherein in the specific color conversion table generated by the specific color conversion table generating portion, the nearby entries are supplied with an equal moving amount to the moving amount of the specific color.

12. An image processing apparatus according to claim 10, wherein in the specific color conversion table generated by the specific color conversion table generating portion, the nearby entries are converted to the same color information as color information after the conversion of the specific color.

13. A controller apparatus comprising:
a scanner portion for outputting a color image which is a scanner RGB signal by scanning an original image;
a PCS generating portion for converting color image which is the scanner RGB signal supplied from the scanner portion to color image which is L* a* b* signal;
a color distribution analyzing portion for analyzing color distribution of color image which is the L* a* b* signal supplied from the PCS generating portion;
an image content judgment portion for judging the content of the inputted color image based on the color distribution analyzed by the color distribution analyzing portion;
a color conversion parameter determining portion for determining color conversion parameter based on an image content judged by the image content judgment portion;
a color conversion portion for executing color conversion upon the inputted color image based on the color conversion parameter determined by the color conversion parameter determining portion; and
an RGB generating portion which receives the converted color image which is the L* a* b* signal supplied from the color conversion portion and generates and outputs standard RGB signal.

14. A controller apparatus comprising:
an RIP processing portion which receives a color image of page description language, executes PDL analysis and outputs a printer signal;
a PCS generating portion for converting to color image which is L* a* b* signal based on the printer signal from the RIP processing portion;
a color distribution analyzing portion for analyzing color distribution of color image which is the L* a* b* signal supplied from the PCS generating portion;
an image content judgment portion for judging the content of the inputted color image based on the color distribution analyzed by the color distribution analyzing portion;
a color conversion parameter determining portion for determining color conversion parameter based on an image content judged by the image content judgment portion;
a color conversion portion for executing color conversion upon the inputted color image based on the color conversion parameter determined by the color conversion parameter determining portion; and
a printer color signal generating portion which receives the converted color image which is the L* a* b* signal supplied from the color conversion portion and outputs a printer color signal.
